(19) United States
(12) Patent Application Publication
(10) Pub. No.: US 2008/0179841 A1
(43) Pub. Date: Jul. 31, 2008

(54) EXTENSION CHUCK TOOL

(76) Inventor: Tsai-Ching Chen, Fu Hsing Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/627,182

(22) Filed: Jan. 25, 2007

(51) Int. Cl. B23B 31/02

(52) U.S. Cl. 279/143

(57) ABSTRACT

An extension chuck tool includes a shank body and sleeve. The shank body includes a first end forming a working end for connecting to a tool. The shank body includes a second end defining a connecting end for connecting to a power tool. A shank is formed between the first and second ends. The sleeve is pivotally disposed on the shank of the shank body. There is relative rotation between the holding device and the shank body.

### FIELD OF THE INVENTION

The present invention relates to an extension chuck tool.

### DESCRIPTION OF THE RELATED ART

Referring to Taiwan Patent No. 354003, a conventional bit A inserts in a chuck C of an power wrench B, and the chuck C drives the bit A to turn. And sometimes, for changing several standard or several sizes bits, another quick-release chuck would further install.

However, the drive shank 1 of the quick-release chuck inserts in the chuck C and there will be an angle between the drive shank 1 and the axle of the chuck C. And while turning the drive shank 1, the drive shank 1 would have a problem of swaying.

### SUMMARY OF THE INVENTION

It is therefore the purpose of this invention to provide an extension chuck tool, which comprises a shank body and a holding device; the shank body includes a first end and a second end, the first end thereof forms a working end provided for connecting the tool, the second end defines a connecting end connecting to the power tool, and a shank is formed between the two ends; the holding device pivotally disposes on the shank of the shank body. And there is a relative rotating with the shank body.

Other objectives, advantages, and features of the invention will become more apparent from the following detailed description when taken in conjunction with the accompanying drawings.

### BRIEF DESCRIPTION OF THE DRAWINGS

FIG. 1 is a perspective view of an extension chuck tool in accordance with the present invention.

FIG. 2 is an exploded view of an extension chuck tool in accordance with the present invention.

FIG. 3 is a section view of an extension chuck tool in accordance with the present invention, while a user holding on the holding device.

FIG. 4 is a top view of an extension chuck tool in accordance with the present invention, while a user holding on the holding device.

FIG. 5 is a perspective view of an extension chuck tool in accordance with the present invention, while a user holding on the holding device and the extension chuck tool connecting to an power tool.

FIG. 6 is a perspective view of an extension chuck tool of the second embodiment in accordance with the present invention.

FIG. 7 is an exploded view of an extension chuck tool of the second embodiment in accordance with the present invention.

FIG. 8 is a perspective view of an extension chuck tool of the third embodiment in accordance with the present invention.

FIG. 9 is an exploded view of an extension chuck tool of the third embodiment in accordance with the present invention.

### DETAILED DESCRIPTION OF THE PREFERRED EMBODIMENT

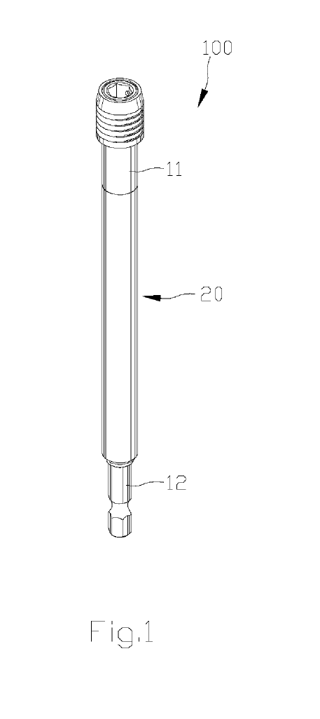

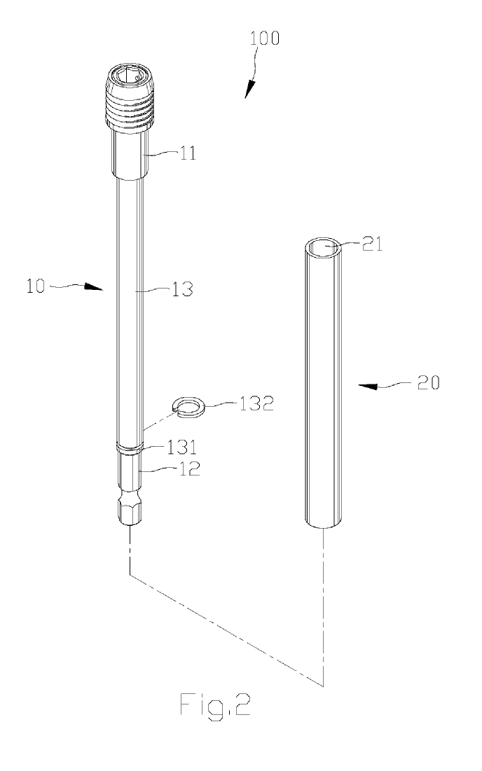

Referring to FIGS. 1 and 2, an extension shank body 100 in accordance with the present invention comprises a shank body 10, a holding device 20 pivotally installing on the shank body 10.

The shank body 10 includes a first end and a second end. The first end forms a working end 11 provided for connecting to the tools like a bit, and in this embodiment, the working end 11 is a quick-release adaptor. The second end of the shank body 10 forms a connecting end 12 provided to insert in the chuck of the power tools.

A shank 13 is defined between the two ends of the shank body 10, and the diameter of the shank 13 is smaller than the working end 11. A fixed groove 131 formed on the shank 13 near the connecting end 12 is provided for receiving a fixed device 132. In the embodiment, the fixed device 132 is a C-clip.

The holding device 20 pivotally installing on the shank 13 of the shank body 10 is provided for a user holding. The holding device 20, which is hollow, includes a pivot hole 21 disposing on the shank 13 of the shank body 10. And there is a relative rotating between the holding device 20 and the shank body 10.

The holding device 20 includes a first end and a second end. The first end thereof retains the working end 111 of the shank body 10, and the second end of the holding device 20 is fixed via the fixed device 132 so that the holding device 20 could pivotally install on the shank 13 and not get away from the shank body 10.

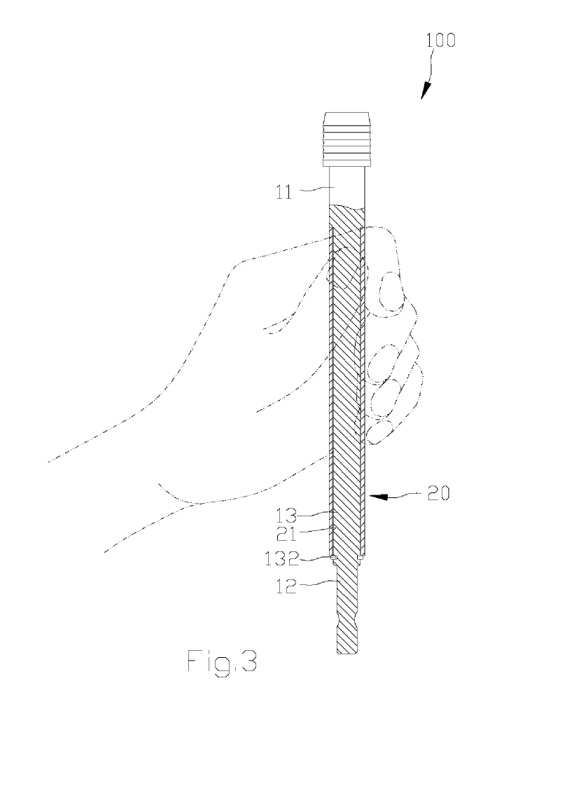

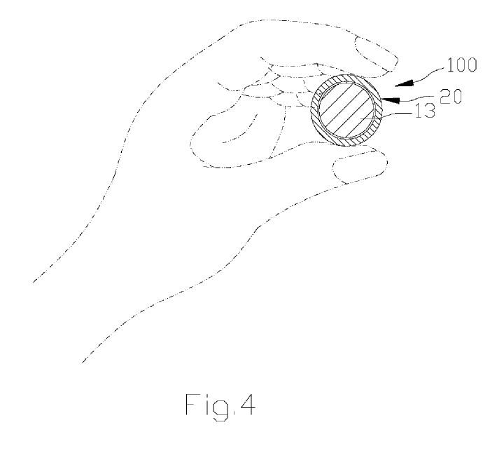

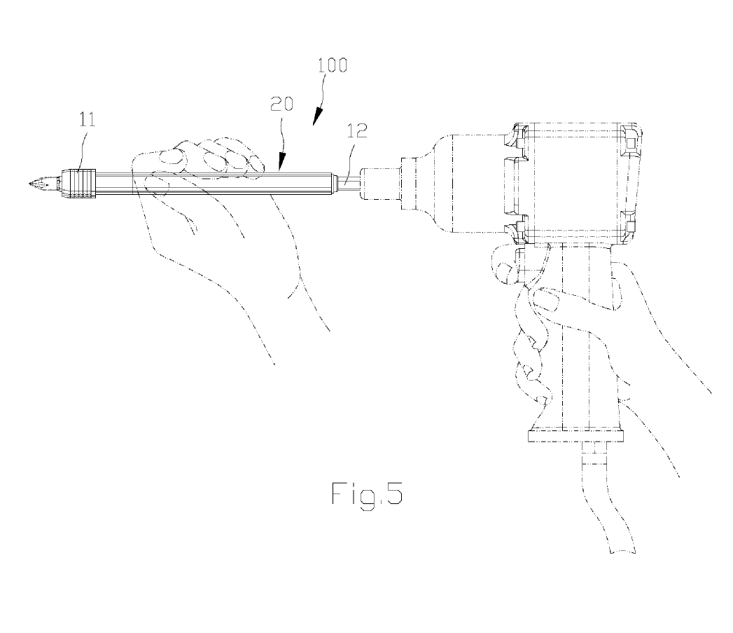

Referring to FIGS. 3 through 5, while using an power tool to drive the shank body 10 turning, a user's hand could hold on the holding device 20 and the shank body 10 could stably work. And there is a relative rotating between the holding device 20 and the shank body 10.

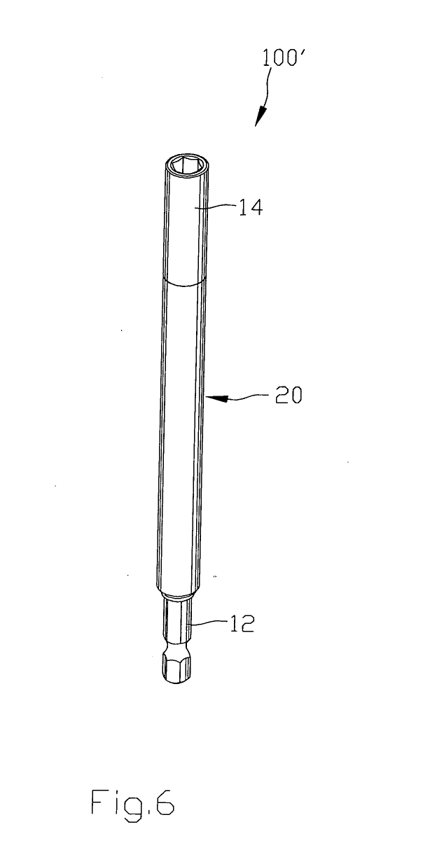

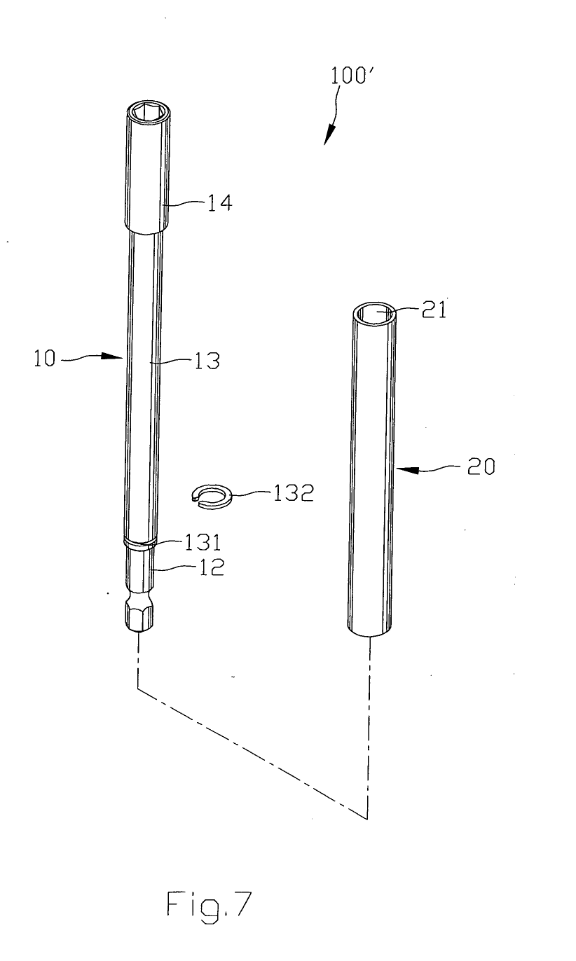

Referring to FIGS. 6 and 7, the second embodiment of the present invention, the chuck 10 includes a working end 14 which is a screwdriver adaptor.

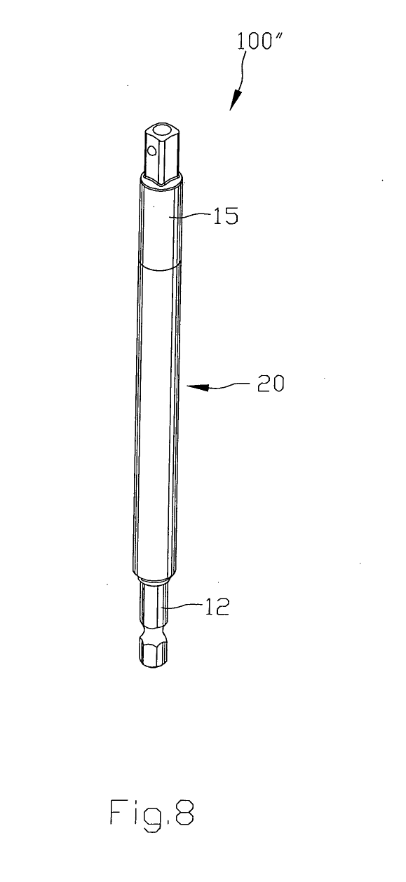

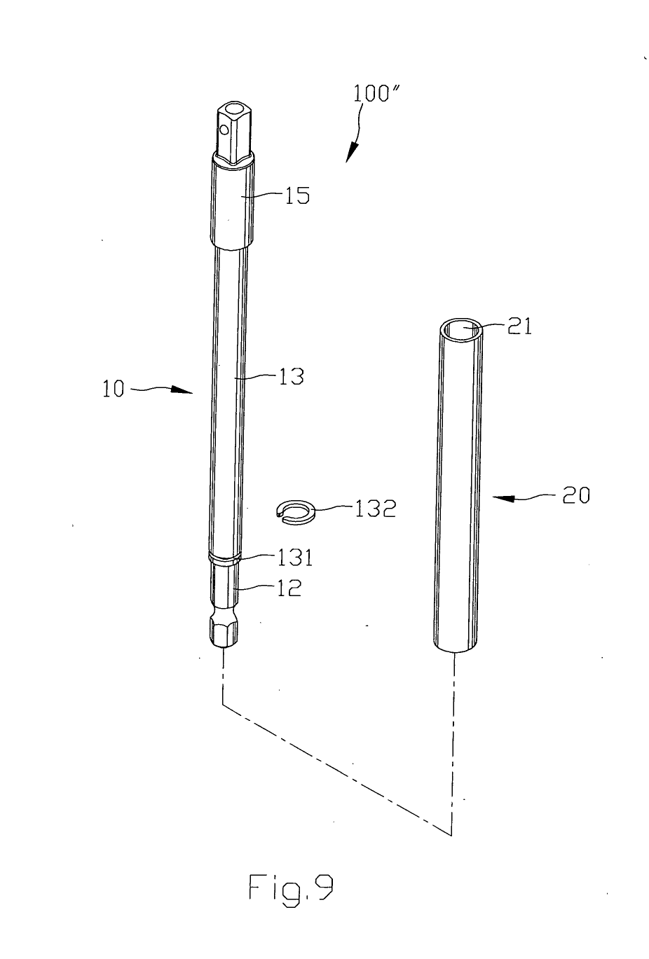

Referring to FIGS. 8 and 9, the third embodiment of the present invention, the chuck 10 includes a working end 15 which is a socket adaptor.

1. An extension chuck tool comprising:
a shank body including a first end and a second end, with the first end defining a working end, with the second end forming a connecting end for connecting to a power tool, with a shank defined between the first and second ends; and
a sleeve pivotally disposed on the shank of the shank body, with relative rotation being allowed between the holding device and the shank body.

2. An extension chuck tool as claimed in claim 1, further comprising a fixed retaining device received on the shank near the connecting end, with the fixed device preventing axial movement of the holding device on the shank thereby and provided for fixing the sleeve.

3. An extension chuck tool as claimed in claim 2, further comprising a retaining groove formed on the shank for receiving the retaining device.

4. An extension chuck tool as claimed in claim 3, wherein the retaining device is a C-clip.

5. An extension chuck tool as claimed in claim 2, wherein a diameter of the shank is smaller than the working end.

6. An extension chuck tool as claimed in claim 5, wherein the sleeve includes a pivot hole disposing on the shank.

7. An extension chuck tool as claimed in claim 1, wherein the working end is a quick-release adaptor.

8. An extension chuck tool as claimed in claim 1, wherein the working end is a bit adaptor.

9. An extension chuck tool as claimed in claim 1, wherein the working end is a socket adaptor.
